(19) United States
(12) Patent Application Publication
(10) Pub. No.: US 2024/0227442 A1
(43) Pub. Date: Jul. 11, 2024

(54) DOUBLE WALL AXLES AND EXTENSION RODS FOR A LUNAR ROVER CHASSIS

(71) Applicant: GM GLOBAL TECHNOLOGY OPERATIONS LLC, Detroit, MI (US)

(72) Inventors: Maria Rossana RUIZ, Detroit, MI (US); Babak Makkinejad, Troy, MI (US); Felipe Cuellar-Ferreira, Madison Heights, MI (US); Douglas James Spry, Auburn Hills, MI (US)

(21) Appl. No.: 18/095,116

(22) Filed: Jan. 10, 2023

(51) Int. Cl. B60B 35/16; B60B 35/00; B60R 16/03; B62D 21/02

(52) U.S. Cl. CPC B60B 35/16; B60B 35/004; B60R 16/03; B62D 21/02; B60B 2900/111; B60K 17/34

(57) ABSTRACT

A lunar rover chassis includes at least two wheels, a power supply, and at least one axle assembly coupled between the at least two wheels. The axle assembly includes an inner axle coupled with the at least two wheels, and an outer wall surrounding the inner axle. The inner axle is configured to rotate to drive rotation of the at least two wheels, the inner axle includes a first conductive surface, and the outer wall includes a second conductive surface. The power supply is electrically connected to the first conductive surface of the inner axle and the second conductive surface of the outer wall, and the power supply is configured to apply a voltage difference between the first conductive surface of the inner axle and the second conductive surface of the outer wall to attract or repel lunar regolith from the outer wall.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to double wall axles and extension rods for a lunar rover chassis, and more particularly, to double wall axles and extension rods including outer wall perforations and charged outer walls to direct lunar regolith.

### SUMMARY

A lunar rover chassis includes at least two wheels, a power supply, and at least one axle assembly coupled between the at least two wheels, the at least one axle assembly comprising an inner axle coupled with the at least two wheels, the inner axle configured to rotate to drive rotation of the at least two wheels, the inner axle comprising a first conductive surface, and an outer wall surrounding the inner axle, the outer wall comprising a second conductive surface. The power supply is electrically connected to the first conductive surface of the inner axle and the second conductive surface of the outer wall, and the power supply is configured to apply a voltage difference between the first conductive surface of the inner axle and the second conductive surface of the outer wall to attract or repel lunar regolith from the outer wall.

In other features, the lunar rover chassis includes a polarity detector configured to detect a polarity of lunar regolith adjacent the lunar rover chassis.

In other features, the power supply is configured to adjust a polarity of the voltage difference applied to between the first conductive surface of the inner axle and the second conductive surface of the outer wall, according to a detected polarity of the lunar regolith adjacent the lunar rover chassis.

In other features, the power supply is configured to control the polarity of the voltage difference applied to between the first conductive surface of the inner axle and the second conductive surface of the outer wall to be opposite to the polarity of the lunar regolith as detected by the polarity detector.

In other features, the at least one axle assembly is a first axle assembly, and the lunar rover chassis further includes a third wheel and a fourth wheel, a second axle assembly coupled between the third wheel and the fourth wheel. The second axle assembly includes a second inner axle coupled with the third wheel and the fourth wheel, the second inner axle configured to rotate to drive rotation of the third wheel and the fourth wheel, the second inner axle comprising a third conductive surface, and a second outer wall surrounding the second inner axle, the second outer wall comprising a fourth conductive surface. A chassis frame is coupled between the first axle assembly and the second axle assembly.

In other features, the power supply is configured to selectively change a polarity of the voltage difference applied between the first conductive surface of the inner axle and the second conductive surface of the outer wall, to selectively attract the lunar regolith to the outer wall or repel the lunar regolith from the outer wall.

In other features, the outer wall includes an outer wall surface, and multiple perforations are defined in the outer wall surface.

In other features, the multiple perforations have a random distribution on the outer wall surface.

In other features, the multiple perforations have a uniform distribution on the outer wall surface.

In other features, at least a portion of the multiple perforations have irregular shapes.

In other features, each of the multiple perforations has a uniform shape.

In other features, each of the multiple perforations defines a circular shape, and a diameter of each of the multiple perforations is in a range between 0.5 cm and 2 cm.

In other features, the lunar rover chassis includes an insulative material between the inner axle and the outer wall.

In other features, the lunar rover chassis includes an air gap between the inner axle and the outer wall.

In other features, the lunar rover chassis includes a chassis frame, wherein the outer wall is fixed to the chassis frame to inhibit rotation of the outer wall during rotation of the inner axle.

A lunar rover chassis includes at least two wheels, and at least one axle assembly coupled between the at least two wheels. The at least one axle assembly includes an inner axle coupled with the at least two wheels, the inner axle configured to rotate to drive rotation of the at least two wheels, and an outer wall surrounding the inner axle, the outer wall including an inner wall surface and an outer wall surface, and the outer wall surface including multiple perforations.

In other features, each of the multiple perforations defines a circular shape, and a diameter of each of the multiple perforations is in a range between 0.5 cm and 2 cm.

In other features, the lunar rover chassis includes at least one of an insulative material and an air gap between the inner axle and the outer wall.

A lunar rover chassis includes one or more wheels, a drive unit configured to drive at least one of the one or more wheels, a frame coupled to the drive unit, at least one lunar rover sensor component or motion control component, and an extension rod assembly coupled to the frame. The extension rod assembly includes an inner rod coupled between the frame and the at least one lunar rover sensor component or motion control component, and an outer wall surrounding the inner rod, the outer wall including an inner wall surface and an outer wall surface, and the outer wall surface including multiple perforations.

In other features, the lunar rover chassis includes a power supply, wherein the inner rod includes a first conductive surface, the outer wall includes a second conductive surface, the power supply is electrically connected to the first conductive surface of the inner rod and the second conductive surface of the outer wall, and the power supply is configured to apply a voltage difference between the first conductive surface of the inner rod and the second conductive surface of the outer wall to attract or repel lunar regolith from the outer wall.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a top cross-sectional view of a chassis for a lunar rover;

FIG. 2 is a front view of an axle of the lunar rover chassis of FIG. 1, illustrating perforations of an outer wall of the axle;

FIG. 3 is cross-sectional view of the axle of FIG. 2, taken along line A-A′ of FIG. 2;

FIG. 4 is a cross-sectional view of the axle of FIG. 3, taken along line B-B′ of FIG. 3;

FIG. 5 is a block diagram of power system components of the lunar rover of FIG. 1; and

FIG. 6 is a top cross-sectional view of another example chassis for a lunar rover, including an extension rod; and

FIG. 7 is a flowchart depicting an example process for controlling a voltage difference applied to the inner axle and the perforated outer wall.

In the drawings, reference numbers may be reused to identify similar and/or identical elements.

### DETAILED DESCRIPTION

When a lunar rover operates on the surface of the moon, charged dust particles are kicked up by the motion of the wheels of the rover, and the charged dust particles adhere to different components of the rover. In some example embodiments herein, this issue is addressed according to example axle arrangements of the lunar rover.

For example, an axle of the rover may be perforated, where the axle includes an inner core wall that is solid, and an outer perforated sleeve that at least partially surrounds the inner core. In various implementations, the inner core wall and the outer perforated sleeve wall may be maintained at different voltages, and the difference in voltage between the inner core wall and the outer perforated sleeve wall may be based on input from one or more polarity sensors (e.g., one or more polarity sensors located on a chassis of the lunar rover to detect a polarity of lunar regolith adjacent the lunar rover, etc.).

In some example embodiments described herein, a double-walled chassis including, e.g., one or more double-walled axles, may protect the integrity of the lunar rover by inhibiting intrusive material such as lunar regolith from entering portions of the rover where the lunar regolith could damage the rover.

The use of perforations on the outer wall of the axle (and/or lunar rover extension rod, etc., as explained below), reduces the weight of the rover parts being sent to the moon. The perforations may allow dust (e.g., lunar regolith) to accumulate naturally on the outer wall of the chassis, adding weight and strength to the vehicle that would further reduce the amount of dust being thrown up by the rover's motion. The shape and placement of the perforations may be specific to a mission of the lunar rover.

In various implementations, a voltage difference may be applied between the inner axle and outer wall, where the voltage difference may direct the lunar regolith, which holds a charge, to accumulate on the outer wall and avoid the more sensitive components contained within.

As described above, the double-walled axle may include a solid inner axle connected to the wheels to drive rotation of the wheels, with a perforated outer wall surrounding the solid inner axle. The perforated wall may have a random distribution of perforations, or a uniform distribution of perforations (or a mix of both). For example, the uniform distribution may include perforations arranged in lines, perforations arranged in equally spaced patterns, etc.

The perforations may have an irregular shape or a regular shape (or a mix of both). For example, the perforations may be circular, square, hexagonal, triangular, etc. In some example embodiments, the perforations may have a circular shape, and a diameter in a range of about 0.5 cm to about 2 cm (such as 1 cm diameter circular perforations). A maximum range may scale with dimensions of the rover. The perforations may have any suitable depth from the surface of the outer wall, or may extend all the way through the outer wall. The axle may have any suitable length, such as being in a range of about 0.5 meters to about two meters (e.g., approximately one meter in length), etc. The perforations may scale with the dimensions of the axle, such as varying by approximately K×L where K is a numerical factor and L is the length of the axle (or rod or other lunar rover component as described further below). For example, for a small hand-held rover, the axle may be 20 cm or less, and the perforations may be proportionately smaller.

In various implementations, the solid inner axle and the outer perforated wall may be made of conductors (or include at least a portion of conductor material), such that the solid inner axle and the outer perforated wall may be electrified (e.g., by a voltage modulator, current modulator, switching circuit, etc., coupled between the solid inner axle, the outer perforated wall, and a power supply such as a battery of the lunar rover).

For example, time-variable voltage differences may be applied to the solid inner axle and the perforated outer wall of the axle (or other surfaces of the rover), to control a speed, direction, etc. of a flow of the lunar dust particles, and therefore control where the lunar regolith is accumulated on the lunar rover, or where the lunar regolith is repelled on the lunar rover.

In various implementations, the voltages applied to the inner solid axle and the outer perforated wall may be controlled by a processing unit circuit, such as a controller, electric current modulators, programming instructions stored in memory, etc.

In some example embodiments, one or more polarity sensors may be located on the lunar rover, such as adjacent the axles of the lunar rover. The polarity sensors may detect a polarity of the lunar regolith adjacent the lunar rover, and the detected polarity may be used by the controller to determine what type of polarity voltage difference to apply to the inner axle and the outer perforated wall (e.g., to attract the lunar regolith to the outer perforated wall by applying an opposite polarity voltage difference, or to repel the lunar regolith by applying a same polarity voltage).

The thickness of the axle, the alloy type of the axle, the locations and shapes of the perforations in the outer wall, an amount of voltage applied to the axle, etc., may be determined via any suitable design techniques, such as a multi-physics simulation and experimentation during design phase, with such simulation tools as ANSYS.

One of the benefits of some of the example axles described herein is the relatively lighter weight compared to sending a solid double-walled axle to the moon (e.g., where outer wall does not include any perforations), which would reduce launch costs. The axle may use the local environment to redirect the lunar dust from less favorable locations on the vehicle (e.g., locations more susceptible to intrusion of dust and damage), to more favorable locations on the vehicle (which may be better protected against lunar regolith).

With lower mass, the lunar rover would be less costly to send to the moon. The perforated axle also reduces the area to which dust could adhere. By electrifying the inner axle and the outer wall, the lunar rover may control the amount and rate of dust particles that attach to sensitive components on the rover's chassis. For example, electrifying the inner axle and outer wall may allow the system to, e.g., alter a center of mass of the lunar rover to a certain extent, by independently controlling a weight of each axle according to the charge on each axle.

The polarity sensors on the lunar rover may determine the electrification of the perforated axle wall, such that the perforated axle wall may have the opposite charge to the prevailing charge of the lunar regolith. As the dust particles attach to the axle, the charge of the dust particles is neutralized by the axle, and the dust particles may then fall off from the axle.

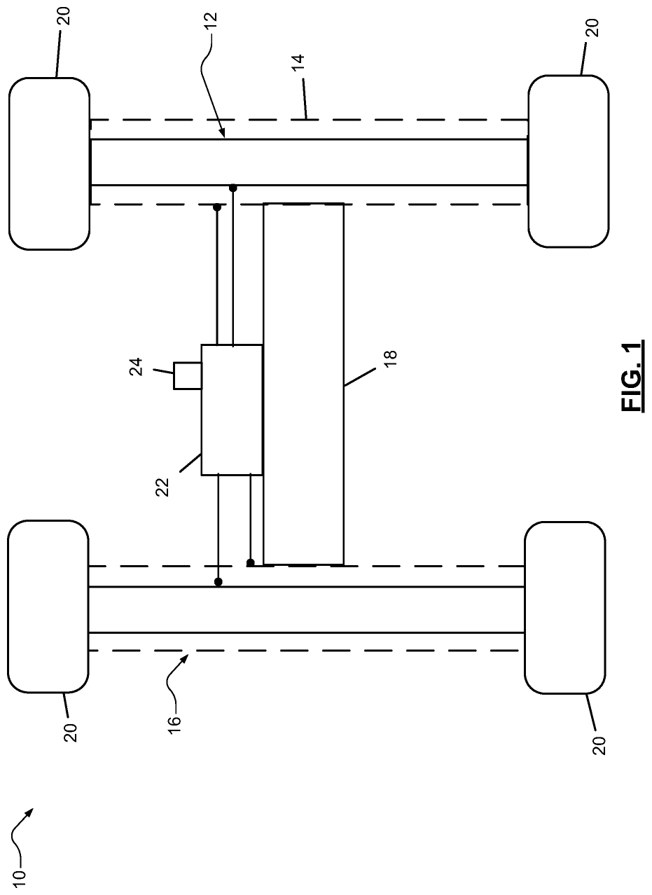

FIG. 1 depicts a top cross-sectional view of a lunar rover chassis 10. The lunar rover chassis includes four wheels 20, two axle assemblies, each between one pair of the wheels 20, and a frame 18 coupled between the two axle assemblies. In other example embodiments, the lunar rover chassis 10 may have more or less axle assemblies, more or less wheels 20, tracks that generate movement for the lunar rover, etc.

Each axle assembly includes an inner axle 12, and an outer wall 14. The inner axle 12 may be a solid axle that is coupled between two wheels 20. The wheels 20 may be fixed to the inner axle 12, such that rotation of the inner axle 12 drives rotation of the wheels 20. For example, the lunar rover may include one or more drive mechanisms, such as an electric motor, that is configured to drive rotation of the inner axle 12 in order to rotate the wheels 20 and move the lunar rover. Although FIG. 1 illustrates a solid axle between the wheels 20, other example embodiments may use a different drive unit arrangement (e.g., a different coupling between the drive unit and the wheels 20), such as half shafts, etc.

The outer wall 14 surrounds the inner axle 12, and may include multiple perforations 16. The perforations 16 may extend partially into the outer wall 14 from an outer surface of the outer wall 14, the perforations 16 may extend all the way through the outer wall 14 to the inner axle 12, etc.

Although the top cross-sectional view of FIG. 1 illustrates a uniform arrangement of perforations along a side of the outer wall 14, the perforations 16 may be distributed over all or only a portion of the outer surface of the outer wall 14 in any suitable arrangement. For example, the perforations 16 may be randomly distributed over the outer surface of the outer wall 14, the perforations may have a uniform arrangement such as a line or other equal distance spacing, etc.

As shown in FIG. 1, the lunar rover chassis 10 includes a power supply 22, which may be coupled to the frame 18. The power supply 22 is configured to apply a voltage to the inner axles 12 and the outer walls 14 of the axle assemblies. For example, the power supply 22 may have a wire or other suitable conductor in electrical contact with a conductive surface of the inner axles 12, and another wire or other suitable conductor in electrical contact with a conductive surface of the outer wall 14. The power supply 22 may apply a voltage difference to the inner axle 12 and the outer wall 14.

For example, the power supply 22 may be configured to selectively apply different polarities of voltage difference to the inner axle 12 and the outer wall 14, to selectively attract or repel lunar regolith from the axle assemblies (e.g., to attract or repel the lunar dust from the outer wall 14).

The power supply 22 may be connected with a polarity detector 24 of the lunar rover chassis 10. The polarity detector 24 may be configured to detect a polarity of the lunar regolith adjacent the lunar rover chassis 10. The power supply 22 may then use the detected polarity of the lunar regolith to selectively adjust the polarity of the voltage difference applied between the inner axle 12 and the outer wall 14, to attract or repel the lunar regolith based on the detected polarity of the lunar regolith.

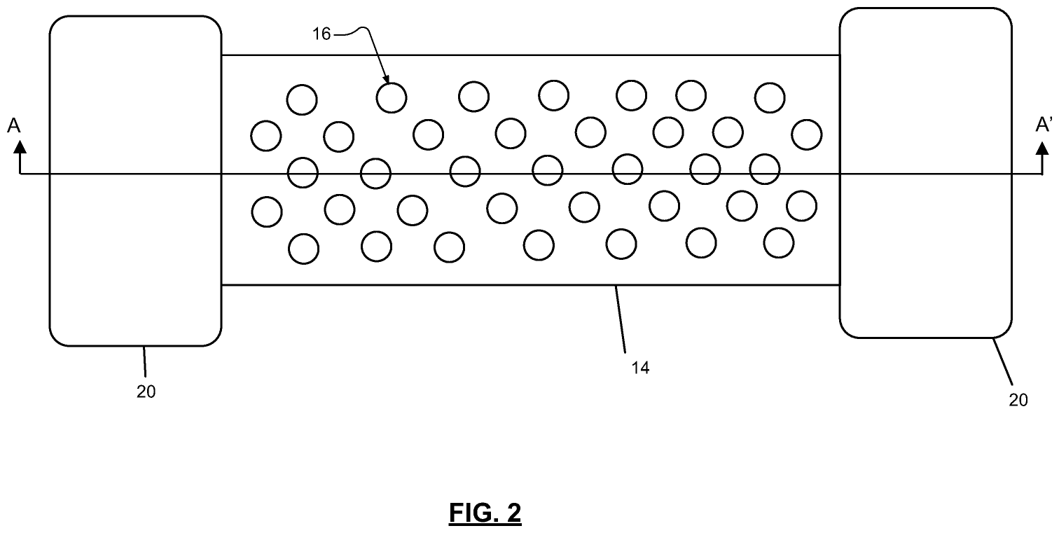

FIG. 2 illustrates a front view of one axle assembly of the lunar rover chassis 10. As shown in FIG. 2, the outer wall 14 is positioned between two wheels 20. In some example embodiments, the outer wall 14 may be fixed to another component of the lunar rover chassis 10, such as the frame 18, to inhibit rotation of the outer wall 14. For example, the inner axle 12 (not shown in FIG. 2) may rotate inside of the outer wall 14, to drive rotation of the wheels 20, while the outer wall 14 remains fixed to the frame 18 and does not rotate.

The outer wall 14 illustrated in FIG. 2 includes multiple perforations 16 spread across an outer surface of the outer wall 14. The perforations 16 are arranged in a mostly uniform pattern, although other embodiments may have randomly distributed perforations, perforations distributed in other patterns, perforations covering more or less of the outer surface of the outer wall 14, etc.

The perforations 16 are circular in FIG. 2. The perforations 16 may have any suitable diameter, such a diameter in a range of about 0.5 cm to about 2 cm (e.g., a diameter of about 1 cm), for an axle of about, for example, one meter in length. In other embodiments, the perforations 16 may have different shapes, may have irregular shapes without geometric edges, different perforations may have different shapes from one another, different perforations may have different dimensions from one another, etc.

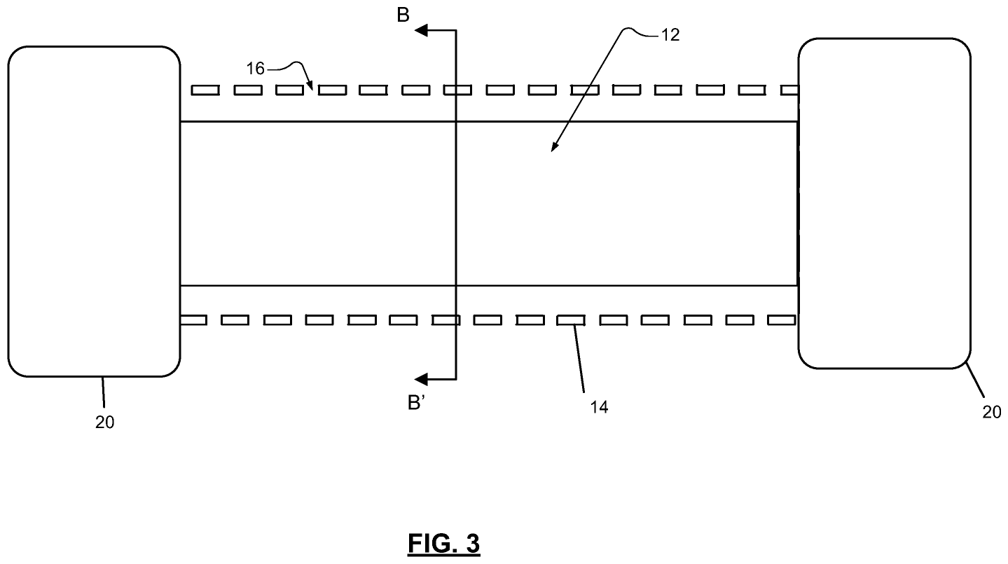

FIG. 3 is a cross-sectional view of the axle assembly of FIG. 2. As shown in FIG. 3, the inner axle 12 is coupled between two wheels 20. As mentioned above, the wheels 20 may be fixed to ends of the inner axle 12, such that rotation of the inner axle 12 drives rotation of the wheels 20.

The outer wall 14 surrounds the inner axle 12, and extends between the two wheels 20. In some example embodiments, the outer wall 14 may have a length which is less than a length of the inner axle 12, to allow rotation of the wheels 20 without the wheels 20 contacting the outer wall 14.

The outer wall 14 has multiple perforations 16. As shown in FIG. 3, the perforations 16 extend all the way through the outer wall 14. The axle assembly may include an air gap between the outer wall 14 and the inner axle 12. The air gap may inhibit the outer wall 14 from contacting the inner axle 12, to avoid a short circuit. For example, if the power supply is applying a voltage difference between the outer wall 14 and the inner axle 12, the air gap may inhibit or prevent a contact short between the outer wall 14 and the inner axle 12.

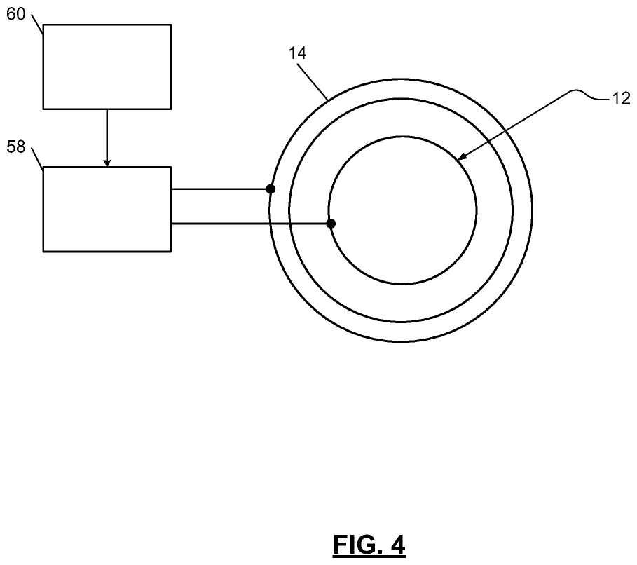

FIG. 4 illustrates a side cross-sectional view of the axle assembly of FIG. 3. As shown in FIG. 4, a power supply 60 is coupled to a current modulator, to apply current and/or voltage to the axle assembly. The power supply 60 may be similar to the power supply 22 of FIG. 1.

As shown in FIG. 4, the current modulator 58 includes a wire (or other suitable conductor) connected to the inner axle 12, and another wire or other conductor connected to the outer wall 14. The current modulator 58 may selectively supply current and/or voltage from the power supply 60 to the inner axle 12 and the outer wall 14.

For example, in some implementations the power supply 60 and current modulator 58 may be configured to apply voltages such that the inner axle 12 is at an approximately ground voltage level, and the current modular can apply a positive or negative voltage to the outer wall 14 to attract or repel lunar regolith (which may be based on a polarity of the lunar dust as detected by the polarity detector 24 of FIG. 1). In various implementations, the outer wall 14 may be charged with an opposite voltage to attract lunar dust, and then the charge of the lunar dust may be neutralized such that the lunar dust falls off the axle (which may include changing a polarity of the outer wall 14 after lunar dust is attracted to the wall, etc.).

Charging the outer wall 14 with an opposite polarity to the lunar regolith may cause lunar dust to collect on the outer wall 14 instead of attaching to the inner axle 12 (and the inner axle 12 may be charged with a same polarity as the lunar regolith to further repel the lunar regolith from the inner axle 12). This polarity approach may further protect the inner axle 12 from the lunar regolith, and protect inner working components of the inner axle 12 or other internal components of the lunar rover.

In some example embodiments, the outer wall 14 may be charged with a same polarity as regolith accumulated on the outer wall 14, in order to control shedding of adhered lunar regolith material. The shedding of adhered material may be adjusted for weight control for the lunar rover, may assist with cleaning the axle or other components of the lunar rover, etc.

The outer wall 14 and inner axle 12 may each have a uniform voltage across their surfaces. For example, a surface of the outer wall 14 and a surface of the inner axle 12 may each have a continuous conductor material or be made of a continuous conductor material, that spans the length of the outer wall 14 and the length of the inner axle 12. Alternatively, in some example embodiments the outer wall 14 and/or inner axle 12 may have multiple independent conductive sections, which can be independently controlled for polarity (e.g., to collect lunar dust at a center of the axle, or to collect lunar dust away from the center of the lunar rover, etc., by using a largest opposite polarity charge at portions of the outer wall 14 where lunar dust collection is most desired).

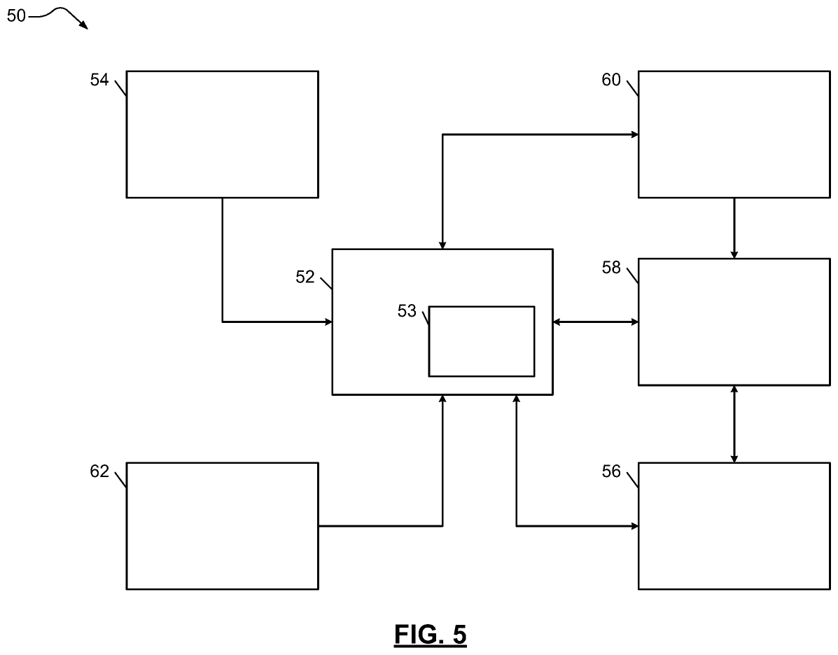

FIG. 5 is a block diagram of power system components of the lunar rover of FIG. 1. As shown in FIG. 5, the power system 50 includes a power supply 60 and a controller 52. The power supply 60 provides power to the controller 52 for operation of the controller 52, and may selectively provide power to the axle and perforated wall 56 via the current modulator.

For example, the polarity sensor 54 may detect a polarity of the lunar regolith adjacent the lunar rover chassis 10, and provide the detected polarity to the controller 52. The controller 52 may then control the current modulator 58 to apply a specified voltage difference to the axle and perforated wall 56.

FIG. 5 also illustrates temperature sensors 62. The temperature sensors 62 may be used for monitoring temperature of components of the lunar rover, such as batteries, etc. Although FIG. 5 illustrates one example embodiment of components of the power system 50, other embodiments may include more or less components, components in different connection arrangements, etc.

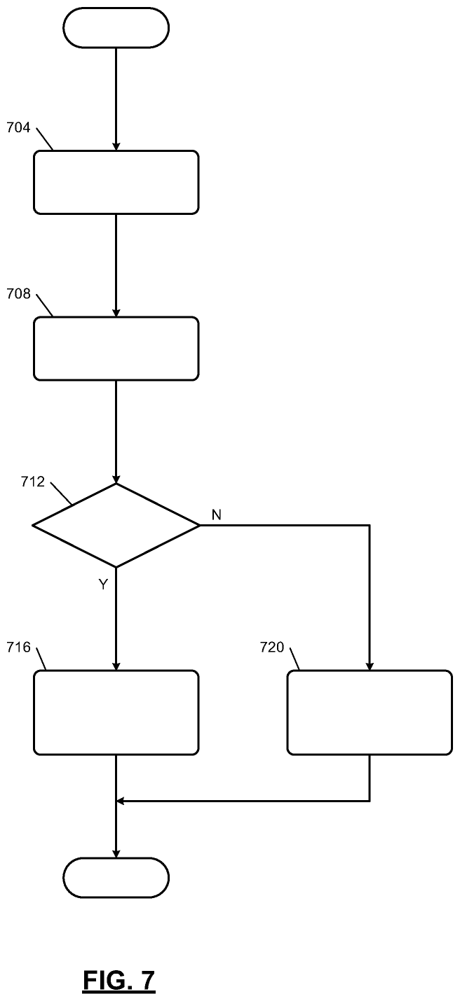

As shown in FIG. 5, the controller 52 includes computer-executable instructions 53. The computer-executable instructions 53 may be stored in memory associated with the controller 52, stored in other memory that is accessed by the controller 52 to execute the computer-executable instructions 53, etc. For example, the computer-executable instructions 53 may include instructions for controlling voltages applied to the axle and perforated wall 56, based on, e.g., a polarity of lunar regolith as detected by the polarity sensors 54. An example process for controlling the voltages applied to the axle and perforated wall 56, which may be stored in the computer-executable instructions 53, is described further below with reference to FIG. 7.

Although some example embodiments are described herein with reference to an axle of a driveline of the lunar rover, in other example embodiments features described herein may be used for lunar rover components other than an axle or a driveline component. For example, use of a perforated outer wall of a rod or frame component of the lunar rover may reduce weight of the lunar rover, a charge may be applied to an outer wall of a rod, frame, etc. of the lunar rover to control attraction or repelling of lunar regolith (e.g., based on a detected polarity of the lunar regolith), etc.

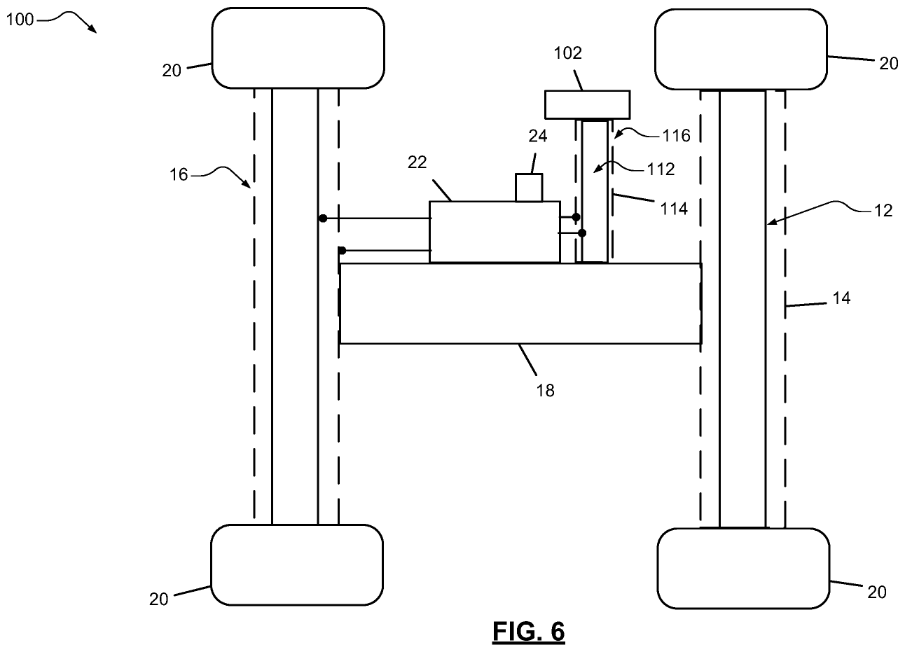

As an example of a non-driveline component, FIG. 6 is a top cross-sectional view of another example chassis 100 for a lunar rover, including an extension rod. The chassis 100 may be similar to the lunar rover chassis 10 of FIG. 1, but the chassis 100 includes an extension rod. The extension rod may include the inner rod 112 illustrated in FIG. 6, and the outer wall 114.

For example, the extension rod may be coupled between the frame 18 and a sensor component or motion control component 102 of the lunar rover. Example components may include, but are not limited to, a camera, a different type of vision sensor, a temperature sensor, a polarity sensor, a movement arm, etc.

The inner rod 112 and the outer wall 114 of the extension rod may be similar to the inner axle 12 and the outer wall 14 of FIG. 1. For example, the outer wall 114 of FIG. 6 may include multiple perforations 16, to reduce a weight of the extension arm. The power supply 22 may apply a voltage difference between the outer wall 114 and the inner rod 112 of the extension arm.

FIG. 7 is a flowchart depicting an example process for controlling a voltage difference applied to the inner axle and the perforated outer wall, to attract lunar regolith to the perforated outer wall based on the detected polarity of the lunar regolith. The process may be performed by, e.g., the controller 52 of FIG. 5. For example, the controller 52 may execute the computer-executable instructions 53 to implement steps of the process illustrated in FIG. 7.

At 704, the controller is configured to apply a neutral voltage (e.g., a ground voltage) to the inner axle. The controller then obtains a polarity of lunar regolith adjacent the lunar rover at 708. The polarity of the lunar regolith may be obtained by, e.g., the polarity sensors 54 illustrated in FIG. 5.

At 712, the controller determines whether the detected polarity of the lunar regolith (e.g., lunar dust), is positive. If so, the controller is configured to apply a negative voltage to the perforated outer wall at 716, to attract the lunar regolith (e.g., because the applied negative voltage is opposite to the detected positive voltage of the lunar regolith). If the controller determines at 712 that the detected polarity of the lunar regolith is negative, the controller is configured to apply a positive voltage to the perforated outer wall at 720 to attract the lunar regolith.

Although FIG. 7 illustrates applying an opposite voltage to attract the lunar regolith, it should be appreciated that in other embodiments a same voltage polarity as the lunar regolith polarity may be applied to the perforated outer wall, such as when it is desired to repel the lunar regolith from the perforated outer wall. Also, in other embodiments a different, non-neutral voltage may be applied to the inner axle. For example, a same polarity as the lunar regolith may be applied to the inner axle to inhibit lunar dust from attaching to the inner axle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a programmable logic controller (PLC); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Some example embodiments may include a system on chip, a field-programmable gate array (PFGA), etc. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, (vi) ladder logic, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A lunar rover chassis comprising:
at least two wheels;
a power supply; and
at least one axle assembly coupled between the at least two wheels, the at least one axle assembly comprising:
an inner axle coupled with the at least two wheels, the inner axle configured to rotate to drive rotation of the at least two wheels, the inner axle comprising a first conductive surface; and
an outer wall surrounding the inner axle, the outer wall comprising a second conductive surface;
wherein the power supply is electrically connected to the first conductive surface of the inner axle and the second conductive surface of the outer wall, and the power supply is configured to apply a voltage difference between the first conductive surface of the inner axle and the second conductive surface of the outer wall to attract or repel lunar regolith from the outer wall.

2. The lunar rover chassis of claim 1, further comprising a polarity detector configured to detect a polarity of lunar regolith adjacent the lunar rover chassis.

3. The lunar rover chassis of claim 2, wherein the power supply is configured to adjust a polarity of the voltage difference applied to between the first conductive surface of the inner axle and the second conductive surface of the outer wall, according to a detected polarity of the lunar regolith adjacent the lunar rover chassis.

4. The lunar rover chassis of claim 2, wherein the power supply is configured to control the polarity of the voltage difference applied to between the first conductive surface of the inner axle and the second conductive surface of the outer wall to be opposite to the polarity of the lunar regolith as detected by the polarity detector.

5. The lunar rover chassis of claim 1, wherein the at least one axle assembly is a first axle assembly, the lunar rover chassis further comprising:
a third wheel and a fourth wheel;
a second axle assembly coupled between the third wheel and the fourth wheel, the second axle assembly including:
a second inner axle coupled with the third wheel and the fourth wheel, the second inner axle configured to rotate to drive rotation of the third wheel and the fourth wheel, the second inner axle comprising a third conductive surface; and
a second outer wall surrounding the second inner axle, the second outer wall comprising a fourth conductive surface; and
a chassis frame coupled between the first axle assembly and the second axle assembly.

6. The lunar rover chassis of claim 1, wherein the power supply is configured to selectively change a polarity of the voltage difference applied between the first conductive surface of the inner axle and the second conductive surface of the outer wall, to selectively attract the lunar regolith to the outer wall or repel the lunar regolith from the outer wall.

7. The lunar rover chassis of claim 1, wherein the outer wall includes an outer wall surface, and multiple perforations are defined in the outer wall surface.

8. The lunar rover chassis of claim 7, wherein the multiple perforations have a random distribution on the outer wall surface.

9. The lunar rover chassis of claim 7, wherein the multiple perforations have a uniform distribution on the outer wall surface.

10. The lunar rover chassis of claim 7, wherein at least a portion of the multiple perforations have irregular shapes.

11. The lunar rover chassis of claim 7, wherein each of the multiple perforations has a uniform shape.

12. The lunar rover chassis of claim 7, wherein:
each of the multiple perforations defines a circular shape; and
a diameter of each of the multiple perforations is in a range between 0.5 cm and 2 cm.

13. The lunar rover chassis of claim 1, further comprising an insulative material between the inner axle and the outer wall.

14. The lunar rover chassis of claim 1, further comprising an air gap between the inner axle and the outer wall.

15. The lunar rover chassis of claim 1, further comprising a chassis frame, wherein the outer wall is fixed to the chassis frame to inhibit rotation of the outer wall during rotation of the inner axle.

16. A lunar rover chassis comprising:
at least two wheels; and
at least one axle assembly coupled between the at least two wheels, the at least one axle assembly comprising:
an inner axle coupled with the at least two wheels, the inner axle configured to rotate to drive rotation of the at least two wheels; and
an outer wall surrounding the inner axle, the outer wall including an inner wall surface and an outer wall surface, and the outer wall surface including multiple perforations.

17. The lunar rover chassis of claim 16, wherein:
each of the multiple perforations defines a circular shape; and
a diameter of each of the multiple perforations is in a range between 0.5 cm and 2 cm.

18. The lunar rover chassis of claim 16, further comprising at least one of an insulative material and an air gap between the inner axle and the outer wall.

19. A lunar rover chassis comprising:
one or more wheels;
a drive unit configured to drive at least one of the one or more wheels;
a frame coupled to the drive unit;
at least one lunar rover sensor component or motion control component;
an extension rod assembly coupled to the frame, wherein the extension rod assembly includes:
an inner rod coupled between the frame and the at least one lunar rover sensor component or motion control component; and
an outer wall surrounding the inner rod, the outer wall including an inner wall surface and an outer wall surface, and the outer wall surface including multiple perforations.

20. The lunar rover chassis of claim 19, further comprising a power supply, wherein:
the inner rod includes a first conductive surface;
the outer wall includes a second conductive surface;
the power supply is electrically connected to the first conductive surface of the inner rod and the second conductive surface of the outer wall; and
the power supply is configured to apply a voltage difference between the first conductive surface of the inner rod and the second conductive surface of the outer wall to attract or repel lunar regolith from the outer wall.
